(19) United States
(12) Patent Application Publication
(10) Pub. No.: US 2002/0135152 A1
(43) Pub. Date: Sep. 26, 2002

(54) Airbag suspension strut and method of repairing airbag suspension strut

(76) Inventor: William Lovins, Coral Springs, FL (US)

Correspondence Address: MALIN HALEY AND DIMAGGIO, PA, 1936 S ANDREWS AVENUE, FORT LAUDERDALE, FL, 33316, US

(21) Appl. No.: 09/813,393

(22) Filed: Mar. 21, 2001

(51) Int. Cl. B60G 1/00

(52) U.S. Cl. 280/124.157; 280/6.15

(57) ABSTRACT

An airbag suspension strut and method of repairing an airbag suspension strut that includes a flattened neck portion on the cap portion of the airbag suspension strut so that a boot or replacement boot may be attached on the flattened outside surface of the cap section and the outside surface of the strut assembly.

### BACKGROUND OF THE INVENTION

1. Field of the Invention

This invention relates generally to the field of airbag suspension struts and a method for repairing the inflatable boots incorporated in airbag suspension struts.

2. Description of Related Art

Airbag suspension struts are generally known for trucks and luxury cars. They provide a comfortable ride for vehicle passengers beyond that available from conventional pneumatic struts. These struts incorporate boots which are generally airtight and which inflate to provide a veritable cushion of air for those inside the vehicle. The cushion of air makes for an especially smooth ride.

The boots maintain approximately 40 pounds of pressure. However, the inflatable boots that these systems incorporate will fail from damage caused by an accident or from excessive wear. The failure point has often been found to be at the low point of the rubber when the boot is not inflated.

These struts are commonly manufactured by a method which attaches the top end of the boot to the inside surface of a cap portion of the strut. To keep the top end of the boot in place, the cap is crimped during manufacture, sandwiching the rubber boot between the rubber boot between a ring and the cap. Thus, if the boot fails, a replacement boot cannot be attached in a generally airtight manner as was the original boot. Therefore, under the present art, replacement of a boot on a strut with a crimped cap portion is impossible because the crimping prevents a seal between a replacement boot and the cap portion. The struts must then be replaced entirely at a cost upwards of $500.00 each.

The present invention allows for the replacement of boots on the strut. The outer surface of the strut is made generally smooth, and a boot is attached in an airtight manner to the outer surface of the cap. Thus, the boot may be replaced while the rest of the strut is reused, whether the embodiment is an alteration of a strut or a strut originally made in accordance with the invention. The boot replacement would be significantly cheaper than the procedure used before this invention.

### BRIEF SUMMARY OF THE INVENTION

It is an object of this invention to provide an airbag suspension strut that does not use crimping of the cap portion to attach a boot. It is also an inexpensive method of repairing an airbag suspension strut with a faulty or damaged boot. It is an object of this invention to provide an airbag strut that attaches on the outside of the cap portion. It is further an object of the invention to provide a strut that does not use the crimping of the cap to attach the boot.

In one embodiment, the invention comprises a top end attached to an outer surface of a cap portion of an upper mount assembly and a bottom end attached to an outer surface of a strut assembly. In another embodiment, the boot further comprises a flexible, generally non-expandable material. In yet another embodiment, the top end of the inflatable boot is attached to the cap by a first clamp such as a T-bar clamp or metal or nylon band. In still another embodiment, the bottom end is attached to the strut assembly by a second clamp such as a T-bar clamp or metal or nylon band. In yet still another embodiment, the cap portion has a neck and a lip below the neck, so that the top end of the boot extends over the lip and attaches at the neck. In another embodiment, the neck is generally flat. In still another embodiment, the neck is first crimped and then machined to be generally flat.

In still another embodiment, the invention is a method of repairing an airbag suspension strut having an inflatable boot attached at a top end to a inner surface of a cap portion of an upper mount assembly at a crimped section of a neck on the cap, comprising removing the boot, generally machine flattening the outer surface of the crimped section, attaching a top end of a replacement boot to an outer surface of the cap portion at the generally flattened section of the neck, and attaching a bottom end to an outer surface of a strut assembly. In yet still another embodiment, the invention is the airbag suspension strut, comprising an inflatable boot, wherein a top end of the boot is attached to an outer surface of a cap portion of an upper mount assembly and a bottom end of the boot is attached to an outer surface of a strut assembly. In yet still another embodiment, the invention is an airbag suspension strut, comprising an inflatable boot wherein a top end of the boot is attached to an outer surface of a cap portion of an upper mount assembly by a first T-bar clamp, and a bottom end of the boot is attached to an outer surface of a strut assembly by a second T-bar clamp, and wherein the outer surface of the cap portion further comprises a flat neck and a lip and the first T-bar attaches the top end of the boot at the flat neck.

In accordance with these and other objects which will become apparent hereinafter, the instant invention will now be described with particular reference to the accompanying drawings.

### BRIEF DESCRIPTION OF THE SEVERAL VIEWS OF THE DRAWINGS

FIG. 1 is a cross section view of an airbag suspension strut known in the art.

FIG. 2 is a cross section view of one embodiment of the invention.

FIG. 3 is a cross section view of the cap portion of a repaired airbag suspension strut in accordance with the invention.

These figures are illustrative only and are not intended to limit the invention in any way.

### DETAILED DESCRIPTION OF THE INVENTION

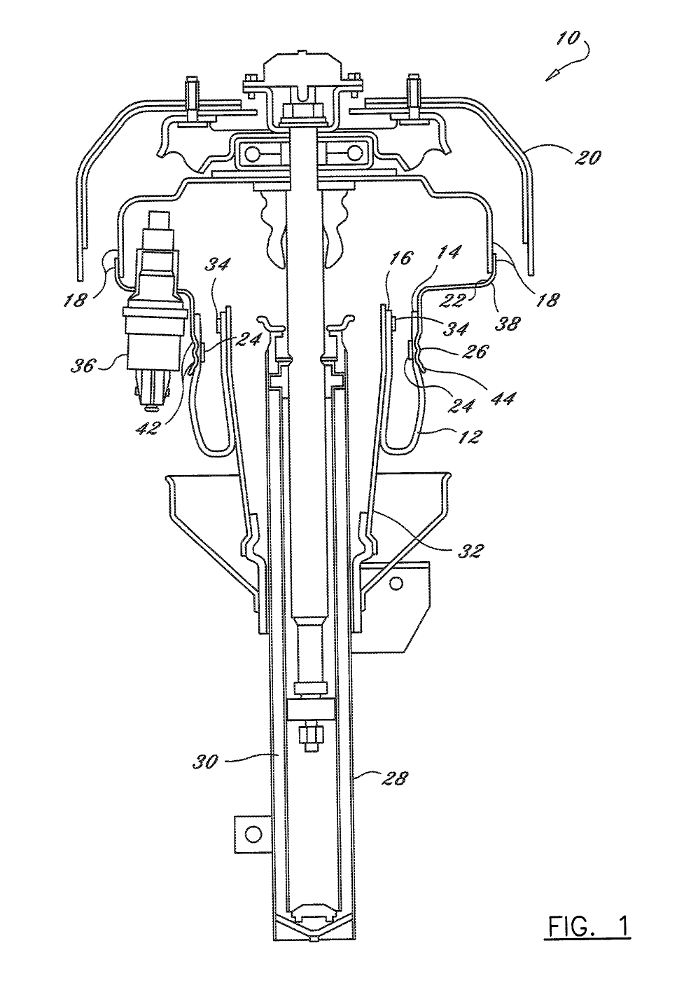

Air bag suspension struts are generally known in the art and are shown in FIG. 1 as 10. Each strut 10 has an inflatable boot 12, with a top end 14 and a bottom end 16. The top end 14 is attached to a cap portion 18 on the strut 10 which is attached to the upper mount assembly 20. As shown, the top end 14 is attached to the inner surface 22 of the cap portion 18 of the strut 10. The top end 14 of the boot 12 is sandwiched between a band 24 or clamp and the inner surface 22 of the cap 18 of the strut 10. The cap 18 is then crimped all the way around it at a crimped portion 26 as shown in FIG. 1.

The bottom end 16 of the boot 12 is attached to the outer surface 28 of the strut assembly 30. As shown, the strut assembly 30 may further comprise a conic section 32. The bottom end 16 of the boot 12 may attach to the outer surface of the conic section 32 portion of the outer surface 28 of the strut assembly 30. The bottom end 16 of the boot 12 is attached by a band or clamp 34. As shown, a solenoid valve 36 attached to the cap 18, is typically used to inflate and deflate the boot 12.

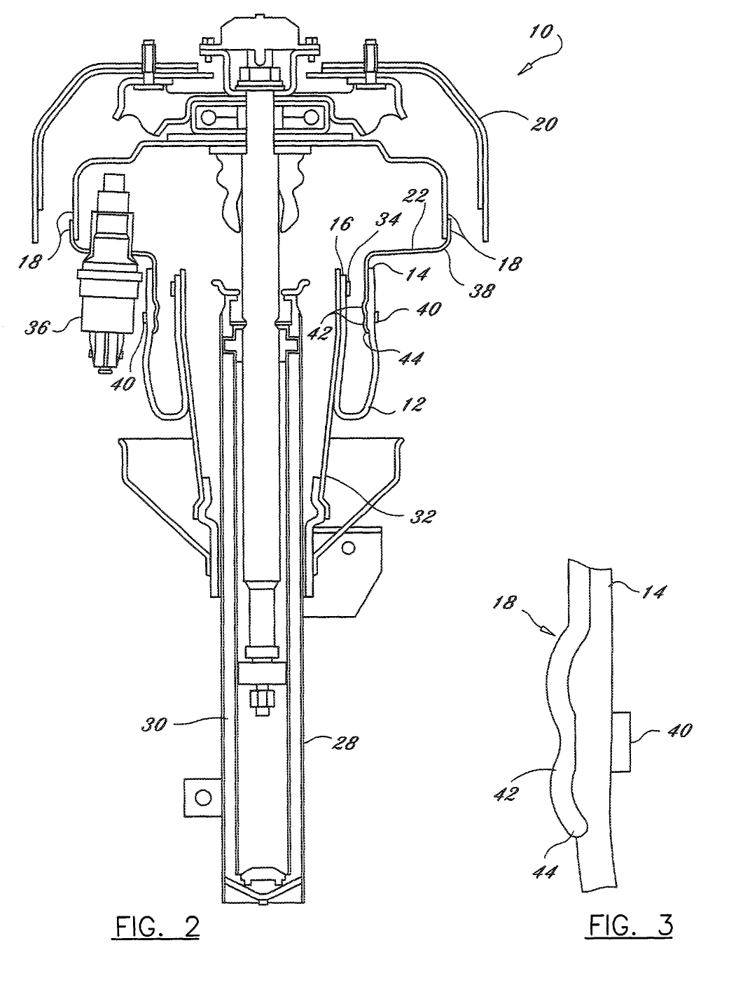

The present invention is illustrated in FIG. 2. The top end 14 of the boot 12 is attached to the outer surface 38 of the cap 18. The outer surface 38 of the cap 18 is such that an a generally airtight seal may be made between the top end 14 of the boot 12 and the cap 18. The bottom end 16 is attached to the outer surface 26 of the strut assembly, as shown in FIG. 1. The attachment may be by a clamp 40 such as a T-bar clamp, a band of nylon, steel or other appropriate material known in the art or other appropriate attachment means as known in the art. The boot 12 may be of appropriate flexible, generally non-expandable material such as an appropriate elastomer as known in the art. The replacement boot may also be made of a wire-reinforced material. However, other materials known in the art are also contemplated.

Also in the present invention, the bottom end 16 of the boot 12 is attached to the outer surface 28 of the strut assembly 30. As shown, the strut assembly 28 may comprise a conic section 32. The bottom end 16 may attach to the conic section 32 of the strut assembly 30. The bottom end 14 may be attached by a clamp such as a T-bar clamp, a band of nylon, steel or other appropriate material known in the art or other appropriate attachment means known in the art. The boot 12 may be of appropriate flexible, generally non-expandable material such as an elastomer as known in the art. However, other materials are also contemplated.

In the present invention, the outer surface 38 of the cap 18 may further comprise a neck 42 and a lip 44. The outer surface of the neck 42 may be manufactured to be generally flat or may be machined to be generally flat. If the strut 12 had been made by crimping the neck 42 to attach the top end 14 of the boot 12 to the cap 18, then the outer surface of the neck 42 is machined to be generally flat with a lathe or other method known in the art. The flat surface of the neck 42 allows a proper seal between the cap 18 and the boot 12 as described below.

The top end 14 of the boot 12 is placed on the cap 18 so that it extends over the lip 44 and over the neck 42. A clamp 40 or other attachment means attaches the boot 12 over the generally flat portion on the neck 42.

As described above, the neck 42 may be flat in the present invention. The present invention also contemplates the repair of an airbag suspension strut 10. As shown in FIG. 1, a typical airbag suspension strut 10 is originally manufactured with a crimp 26 in the neck 42 of the cap 18, and the top end 14 of the boot 12 is attached to the interior surface of the cap 18.

To repair an airbag suspension strut 10 with a broken or faulty boot 12, the boot 12 is first removed. On the cap 18, the neck 42 is machined generally flat. The neck 42 may be machined manually or by a lathe or other means known in the art. After the neck 42 has been prepared, a new boot 12 is fitted on the strut assembly 30. The bottom end 16 of the boot 12 is attached to the strut assembly 30. If the strut assembly 30 has a conic section 32 as illustrated in FIGS. 1 & 2, then it may be preferable to attach the bottom end 16 of the boot 12 to the conic section 32. The top end 14 of the boot 12 is then fitted over the cap 18 at the generally flattened neck 42. If the cap has a lip 44, the top end 14 of the boot 12 extends over the lip 44 as it goes over the neck 42.

In repairing the airbag strut 10, it does not matter which end of the boot 12 is attached first or if the ends are attached simultaneously. The cap 18 for a repaired airbag strut is illustrated in FIG. 3. Also, although a typical front strut is illustrated in the figures, this invention is equally applicable to rear struts.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An inflatable boot for an airbag suspension strut, comprising:
a top end attached to an outer surface of a cap portion of an upper mount assembly; and
a bottom end attached to an outer surface of a strut assembly.

2. The inflatable boot of claim 1 wherein the boot further comprises a flexible, generally non-expandable material.

3. The inflatable boot of claim 1 wherein the top end is attached by a first clamp.

4. The inflatable boot of claim 3 wherein the first clamp is a T-bar clamp.

5. The inflatable boot of claim 3 wherein the first clamp comprises a metal band.

6. The inflatable boot of claim 3 wherein the first clamp comprises a nylon band.

7. The inflatable boot of claim 1 wherein the bottom end is attached by a second clamp.

8. The inflatable boot of claim 7 wherein the second clamp is a T-bar clamp.

9. The inflatable boot of claim 7 wherein the second clamp comprises a metal band.

10. The inflatable boot of claim 7 wherein the second clamp comprises a nylon band.

11. The inflatable boot of claim 1 wherein the cap portion further comprises a neck and a lip below the neck.

12. The inflatable boot of claim 11 wherein the top end of the boot extends over the lip and attaches at the neck.

13. The inflatable boot of claim 11 wherein the neck is generally flat.

14. The inflatable boot of claim 11 wherein the neck is first crimped and then machined to be generally flat.

15. A method of repairing an airbag suspension strut having an inflatable boot attached at a top end to a inner surface of a cap portion of an upper mount assembly at a crimped section of a neck on the cap, comprising:
removing the boot;
generally flattening the outer surface of the crimped section;
attaching a top end of a replacement boot to an outer surface of the cap portion at the generally flattened section of the neck; and
attaching a bottom end to an outer surface of a strut assembly.

16. The method of claim 15 wherein the replacement boot comprises a flexible, generally non-expandable material.

16. The method of claim 15 wherein the top end is attached by a first clamp.

17. The method of claim 17 wherein the first clamp is a T-bar clamp.

18. The method of claim 15 wherein the first clamp comprises a metal band.

19. The method of claim 15 wherein the first clamp comprises a nylon band.

20. The method of claim 15 wherein the bottom and is attached by a second clamp.

21. The method of claim 21 wherein the second clamp is a T-bar clamp.

22. The method of claim 21 wherein the second clamp comprises a method band.

23. The method of claim 21 wherein the second clamp is a nylon band.

24. An airbag suspension strut, comprising:
an inflatable boot, wherein a top end of the boot is attached to an outer surface of a cap portion of an upper mount assembly; and
a bottom end of the boot is attached to an outer surface of a strut assembly.

25. The strut of claim 25 wherein the boot comprises a flexibly, generally non-expandable material.

26. The strut of claim 25 wherein the top end is attached by a first clamp.

27. The strut of claim 27 wherein the first clamp comprises a T-bar clamp.

28. The strut of claim 27 wherein the first clamp comprises a metal band.

29. The strut of claim 27 wherein the first clamp comprises a nylon band.

30. The strut of claim 25 wherein the bottom end is attached by a second clamp.

31. The strut of claim 31 wherein the second clamp is a T-bar clamp.

32. The strut of claim 31 wherein the second clamp comprises a metal band.

33. The strut of claim 31 wherein the second clamp comprises a nylon band.

34. The strut of claim 25 wherein the cap portion further comprises a neck and a lip below the neck.

35. The strut of claim 35 wherein the top end of the boot extends over the lip and attaches at the neck.

36. The strut of claim 35 wherein the neck is generally flat.

37. The strut of claim 35 wherein the neck is first crimped and then machined generally flat.

38. An airbag suspension strut, comprising:
an inflatable boot;
wherein a top end of the boot is attached to an outer surface of a cap portion of an upper mount assembly by a first T-bar clamp and a bottom end of the boot is attached to an outer surface of a strut assembly by a second T-bar clamp; and
wherein the outer surface of the cap portion further comprises a flat neck and a lip; and the first T-bar attaches the top end of the boot at the flat neck.
